(19) United States
(12) Patent Application Publication
(10) Pub. No.: US 2004/0080797 A1
(43) Pub. Date: Apr. 29, 2004

(54) Scanner

(76) Inventor: Ta-Yi Lee, Taipei (TW)

Correspondence Address: BIRCH STEWART KOLASCH & BIRCH, PO BOX 747, FALLS CHURCH, VA, 22040-0747, US

(21) Appl. No.: 10/443,016

(22) Filed: May 22, 2003

(30) Foreign Application Priority Data
Oct. 25, 2002 (TW) 91217182

(51) Int. Cl. H04N 1/04; H04N 1/46

(52) U.S. Cl. 358/509; 358/474

(57) ABSTRACT

A scanner consists of a base and a lid pivotally engaged with each other. The base includes a light generator and a reflective document scan module. The lid contains a penetrative document scan module. Light generated by the light generator projects to a scanned document located between the base and the lid. Depending on whether the scanned document is a reflective document or a penetrative document, the light may be reflected to the reflective document scan module, or penetrate the penetrative document to reach the penetrative document scan module. Thus the invention has two optical paths for scanning reflective documents and penetrative documents. And the two scan modules may provide different resolutions to scan the reflective documents and penetrative documents.

### FIELD OF THE INVENTION

The invention relates to a scanner and particularly a scanner for scanning reflective documents and penetrative documents with different resolutions.

### BACKGROUND OF THE INVENTION

The technology of using scanners to scan opaque documents (reflective documents) or transparent documents (penetrative documents) is well known in art. In general, the difference between the two is determined by the light projection method of the light generator. If the light generator 10 and the charge-coupled device (CCD) 50 are located on the same side of the scanned document 20, it is reflective scanning (as shown in FIG. 1). In contrast, if the light generator 10 and the CCD 50 are located on the different sides of the scanned document 20, it is penetrative scanning (as shown in FIG. 2).

In a reflective scanner, light emitted from a light generator 10 projects to the scanned document 20 (reflective document) which reflects the light to a mirror set 30 in the reflective scanner to pass through a focus lens 40 and reach the CCD 50. In a penetrative scanner, light emitted from the light generator 10 projects to and penetrates the scanned document 20 (penetrative document) and reaches a mirror set 30 in the penetrative scanner. Then light passes through the focus lens 40 and reaches the CCD 50.

With continuous innovations and gradually decreasing prices, scanners have to be able to scan reflective documents and penetrative documents to earn consumer's favorable acceptance.

Refer to FIGS. 3A and 3B for a conventional scanner that equips reflective and penetrative scanning functions. When in use for reflective scanning, a light generator 10 generates light, projecting to a scanned document (reflective document) 20. The scanned document (reflective document) 20 reflects the light to a mirror set 30 in the scanner. Then the light is projected to a focus lens 40 and a CCD 50. On the other hand, when performing penetrative scanning, light emitted from a light generator 10 is projected to a scanned document (penetrative document) 20, and passes through the scanned document (penetrative document) 20, then travels to the mirror set 30 in the scanner, and projects to the focus lens 40 and the CCD 50. Thus the scanner has both reflective and penetrative scanning functions.

There are other types of scanners for performing both reflective and penetrative scanning functions. Some adopt a moving light generator or a moving mirror set to scan the reflective and penetrative documents. FIGS. 4A and 4B illustrate a scanner with a moving mirror set. For scanning a reflective document 20, a light generator 10 generates light projecting to a scanned document (reflective document) 20. The scanned document (reflective document) 20 reflects the light to a mirror set 30 (located at position A) in the scanner. Then the light is projected to a focus lens 40 and the CCD 50. For scanning a penetrative document 20, light emitted from a light generator 10 is projected to a scanned document (penetrative document) 20, and passes through a scanned document (penetrative document) 20, then travels to a mirror set 30 (located at position B) in the scanner, and projects to a focus lens 40 and the CCD 50. Thus the scanner has both reflective and penetrative scanning functions. However, such a scanner requires a complex structure to move the mirror set. It makes manufacturing and research more inconvenient.

In general, during the scanner performs penetrative scanning, a higher resolution is required to achieve the desired image quality, while reflective scanning achieves a reasonable image quality without a very high resolution. For scanners shown in FIGS. 3A, 3B, 4A and 4B, the same optical path is adopted. In order to save cost, a lower resolution is generally employed. As the resolution used in penetrative scanning is the same as reflective scanning, reflective scanning achieves a required image quality while penetrative scanning cannot get the desired image quality. Therefore, even though a dual-function scanner can perform reflective and penetrative scanning, it cannot provide different resolutions for reflective documents and penetrative documents.

It is obvious that, in addition to providing scanning functions for reflective and penetrative documents, the scanner also gives reflective and penetrative documents different scanning resolutions to achieve the desired scanning effect and quality.

### SUMMARY OF THE INVENTION

The primary object of the invention is to provide a scanner that can scan reflective and penetrative documents, and also offers different scanning resolutions for reflective and penetrative documents.

The invention includes a base and a lid that are pivotally engaged with each other for sandwiching a scanned document laid on the upper surface of the base.

The base has a hollow interior for holding a light generator and a reflective document scan module. The light generator emits light to project to a scanned document laid on the surface of the base. The reflective document scan module receives the light reflected from the scanned document (reflective document), and the light is transformed to image signals corresponding to the scanned document. The lid also has a hollow interior for holding a penetrative document scan module. When the penetrative document scan module receives light which has passed through a scanned document (penetrative document), it transforms the light to image signals corresponding to the scanned document.

To perform scanning for reflective documents, first, place the scanned document between the base and the lid. The light generator emits light to project to the upper surface of the base where the scanned document is laid. The light is reflected by the reflective document to the reflective document scan module which transforms the reflective light to image signals corresponding to the scanned document.

To scan penetrative documents, first, place the scanned document between the base and the lid. The light generator emits light to project to the upper surface of the base where the scanned document is laid. The light penetrates the scanned document and projects to the penetrative document scan module which transforms the penetrative light to image signals corresponding to the scanned document.

Thus, the invention provides two optical paths through locating respectively the reflective document scan module and the penetrative document scan module in the base and the lid. It not only provides functions of scanning reflective documents and penetrative documents, but also offers different scanning resolutions for the reflective documents and penetrative documents.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional scanner for scanning reflective documents.

FIG. 2 is a schematic view of a conventional scanner for scanning penetrative documents.

FIGS. 3A and 3B are schematic views of the optical paths of scanning reflective documents and penetrative documents in a conventional scanner with dual scanning functions.

FIGS. 4A and 4B are schematic views of the optical paths of scanning reflective documents and penetrative documents in another conventional scanner with dual scanning functions.

FIGS. 5A and 5B are schematic views of the optical paths of scanning reflective documents and penetrative documents according to the scanner of the invention.

FIG. 6 is a schematic view of another embodiment of the invention.

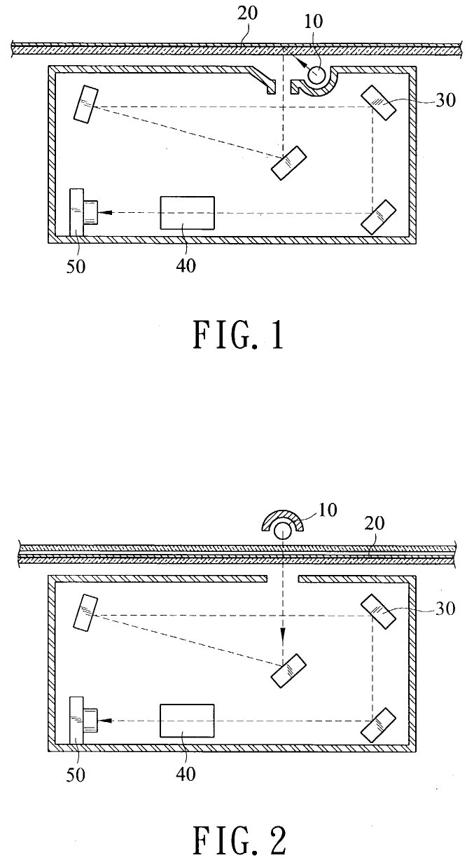

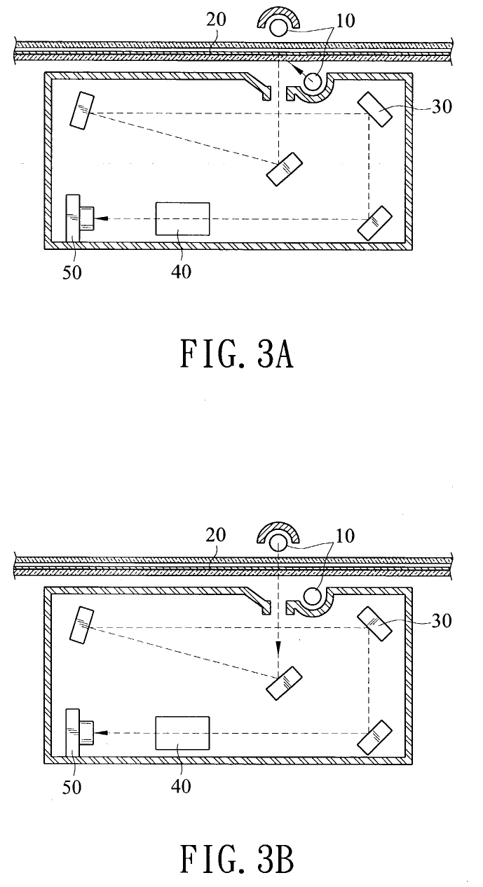

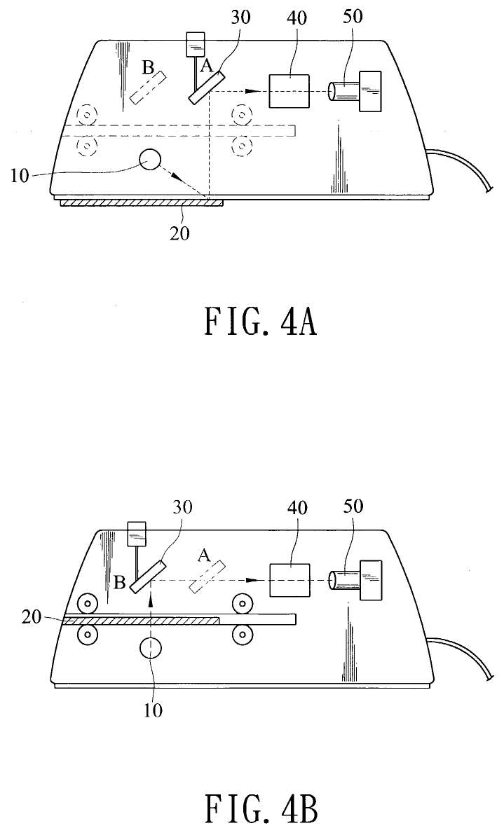

### DESCRIPTION OF THE PREFERRED EMBODIMENTS

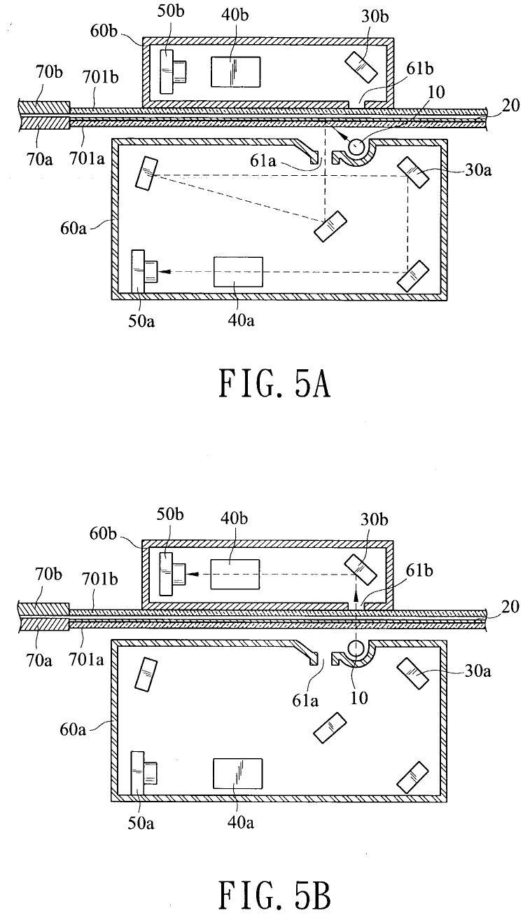

Referring to FIGS. 5A and 5B, the scanner of the invention aims to scan a scanned document 20. It consists of a base 70a and a lid 70b that are pivotally engaged with each other (not shown in the drawings) for sandwiching the scanned document 20 therebetween.

The base 70a has an upper surface for holding the scanned document 20. The interior of the base is hollow for holding a light generator 10, a transparent board 701a and a reflective document scan module. The light generator 10 emits light to project to the upper surface of the base 70a. The transparent board 701a is located on the upper surface of the base 70a to enable the light to pass through the upper surface of the base 70a.

The reflective document scan module receives the light reflected from the scanned document 20 and transforms the reflective light to image signals corresponding to the scanned document 20. It includes a mirror set 30a, a focus lens 40a, a CCD 50a and a casing 60a. The mirror set 30a changes the optical path of the reflective light from the scanned document 20 to the focus lens 40a. The focus lens 40a focuses the light to the CCD 50a which transforms the light to the image signals corresponding to the scanned document 20. The casing 60a has a hollow interior to house the mirror set 30a, focus lens 40a and the CCD 50a. Further, the casing 60a has an opening 61a to enable the reflective light from the scanned document 20 to pass through and reach the mirror set 30a. The mirror set 30a changes the optical path of the reflective light to the focus lens 40a which focuses the light on the CCD 50a.

The lid 70b has a hollow interior for housing the transparent board 701b and a penetrative document scan module. The transparent board 701b is located on a lower surface of the base 70b to enable the light generated by the light generator 10 to penetrate a penetrative scanned document 20 and the transparent board 701b to reach the penetrative document scan module.

The penetrative document scan module receives the light from the penetrative scanned document 20 and transforms the light to image signals corresponding to the scanned document 20. The penetrative document scan module includes a mirror 30b a focus lens 40b, a CCD 50b and a casing 60b. The mirror 30b changes the optical path of the light which penetrates the scanned document 20 (of course the mirror 30b may be one piece or more as long as it directs the light to the focus lens 40b) to the focus lens 40b which focuses the light on the CCD 50a for transforming the light to image signals corresponding to the scanned document 20. The casing 60b has a hollow interior to house the mirror 30b, focus lens 40b and CCD 50b. Further, the casing 60b has an opening 61b to enable the light penetrated the scanned document 20 to pass through and reach the mirror 30b. The mirror 30b changes the optical path of the light to the focus lens 40b which focuses the light on the CCD 50b.

Referring to FIG. 5A, when the invention is used for scanning a reflective scanned document 20, first, the scanned document 20 is sandwiched between the base 70a and the lid 70b. Second, the light generator 10 emits light to project to the upper surface of the base 70a, pass through the transparent board 701a and reach the scanned document 20. The scanned document 20 reflects the light to the reflective document scan module, i.e. the reflective light passes through the opening 61a of the casing 60a and reaches the mirror set 30a. The mirror set 30a changes the optical path of the reflective light to the focus lens 40a which in turn focuses the reflective light on the CCD 50a. The CCD 50a transforms the focused light to image signals corresponding to the scanned document 20.

Referring to FIG. 5B, when the invention is used for scanning a penetrative scanned document 20, first, the scanned document 20 is sandwiched between the base 70a and the lid 70b. Second, the light generator 10 emits light to project to the upper surface of the base 70a, passing through the transparent board 701a and reaching the scanned document 20, then passing through the scanned document 20 and the transparent board 701b and reaching the penetrative document scan module, i.e. the penetrative light passes through the opening 61b of the casing 60b and reaches the mirror 30b. The mirror 30b changes the optical path of the penetrative light to the focus lens 40a, which in turn focuses the penetrative light on the CCD 50a. The CCD 50a transforms the focused light to image signals corresponding to the scanned document 20.

This invention has the reflective document scan module and the penetrative document scan module located respectively in the base and the lid, and forms two optical paths to scan reflective documents and penetrative documents with different resolutions.

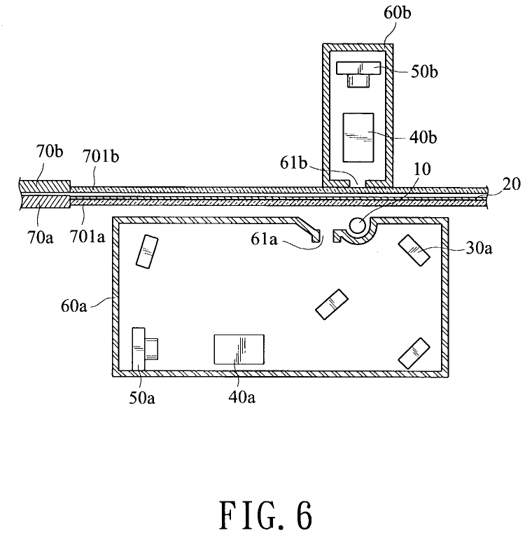

FIG. 6 illustrates another embodiment of the invention in which the mirror 30b of the penetrative document scan module is omitted. The light passes through the penetrative document 20 reaches the focus lens 40b directly for focusing on the CCD 50a.

By means of the construction described above, the invention achieves the following effects:

1. The invention needs only one light generator to provide light required for scanning reflective documents and penetrative documents, thus reduces the cost of the light generator.

2. The invention has the reflective document scan module and the penetrative document scan module, located respectively in the base and the lid to form two optical paths. Thus, if one scan module malfunctions, the malfunctioning scan module can be repaired, while another scan module still works. In addition, different resolutions may be provided to scan reflective documents and penetrative documents.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A scanner for scanning documents, comprising:
a base which has a hollow interior and an upper surface for holding a scanned document including:
a light generator located in the base to emit light to project to the surface of the base where the scanned document is located; and
a reflective document scan module located in the base to receive light reflecting from the scanned document and transform the reflective light to image signals corresponding to the scanned document; and
a lid having a hollow interior and being pivotally engaged with the base for sandwiching the scanned document located on the upper surface of the base, and including:
a penetrative document scan module located in the lid to receive light penetrating through the scanned document and transform the penetrated light to image signals corresponding to the scanned document.

2. The scanner of claim 1, wherein the reflective document scan module includes:
a mirror set located in the base to alter the optical path of the reflective light;
a focus lens located in the base to focus the light whose optical path altered by the mirror set; and
a charge coupled device located in the base to receive the focused light from the focus lens and transform the light to image signals corresponding to the scanned document.

3. The scanner of claim 2, wherein the reflective document scan module further includes a hollow casing for housing the mirror set, the focus lens and the charge coupled device.

4. The scanner of claim 3, wherein the casing has an opening to allow the reflective light to pass through and reach the mirror set.

5. The scanner of claim 1, wherein the penetrative document scan module includes:
a focus lens located in the lid to focus the penetrative light; and
a charge coupled device located in the lid to receive the focused light from the focus lens and transform the light to image signals corresponding to the scanned document.

6. The scanner of claim 5, wherein the penetrative document scan module further includes a hollow casing for housing the focus lens and the charge coupled device.

7. The scanner of claim 6, wherein the casing has an opening to allow the penetrative light to pass through and reach the focus lens.

8. The scanner of claim 5, wherein the penetrative document scan module includes one or more mirror locating in the base to alter the optical path of the penetrative light, and the focus lens focuses the penetrative light on the charge coupled device.

9. The scanner of claim 8, wherein the penetrative document scan module includes a hollow casing for housing the mirror, the focus lens and the charge coupled device.

10. The scanner of claim 9, wherein the casing has an opening to allow the penetrative light to pass through and reach the mirror.

11. The scanner of claim 1, wherein the base further includes a transparent board located on the upper surface thereof to allow the light generated by the light generator to pass through the upper surface of the base.

12. The scanner of claim 1, wherein the lid further includes a transparent board located on a lower surface thereof to allow the light generated by the light generator to pass through the scanned document and the transparent board to reach the penetrative document scan module.
